(19) United States
(12) Patent Application Publication
(10) Pub. No.: US 2024/0064170 A1
(43) Pub. Date: Feb. 22, 2024

(54) SUSPICIOUS DOMAIN DETECTION FOR THREAT INTELLIGENCE

(71) Applicant: International Business Machines Corporation, Armonk, NY (US)

(72) Inventors: Sulakshan Vajipayajula, Suwanee, GA (US); Michael Josiah Bolding, Smyrna, GA (US); Paul Charles James Dunning, Ratoath (IE)

(21) Appl. No.: 17/820,388

(22) Filed: Aug. 17, 2022

(51) Int. Cl. H04L 9/40

(52) U.S. Cl. CPC H04L 63/1483; H04L 63/1416

(57) ABSTRACT

A computer implemented method detects suspicious domains. A computer system determines a homographic similarity between a target domain and a known domain. The compute system compares first registration information for the target domain and second registration information for the known domain to form a registration comparison in response the homographic similarity being sufficiently similar to be potentially suspicious. The computer system compares a set of first landing page images for the target domain and a set of second landing page images for the known domain to form an image comparison in response to a match between the first ownership information for the target domain and the second ownership information for the known domain being absent. The computer system determines a threat level for the target domain based on the image comparison.

### BACKGROUND

### 1. Field

The disclosure relates generally to an improved data processing system, and more specifically, to a computer implemented method, apparatus, system, and computer program product for early warning detection of suspicious websites.

### 2. Description of the Related Art

Cybersecurity involves protecting computer systems and networks from threats such as information disclosure, theft of information, damage to hardware, software, or data. This protection also includes protecting against disruption or misdirection of the services provided by computer systems and networks.

Threat intelligence feeds are an important form of defense to entities such as security operations centers (SOCs) and computer emergency response teams (CERTs). This information can be used to provide additional information about incidents and for formulating actions in response to various threats on the Internet. In obtaining threat intelligence, searches can be performed for suspicious behavior in federated environments.

These threats can include look-alike domains that are used to divert web traffic and distribute malware. For example, a suspicious domain may have a similar homographic spelling that is designed to divert traffic to that domain from a well-known domain. These types of websites diver traffic from well-known domains and can harm brands of companies and phish for customer data.

### SUMMARY

According to one illustrative embodiment, a computer implemented method detects suspicious domains. A computer system determines a homographic similarity between a target domain and a known domain. The computer system compares first ownership information for the target domain and second ownership information for the known domain to form an ownership comparison in response the homographic similarity being sufficiently similar to be potentially suspicious. The computer system compares a set of first landing page images for the target domain and a set of second landing page images for the known domain to form an image comparison in response to a match between the first ownership information for the target domain and the second ownership information for the known domain being absent. The computer system determines a threat level for the target domain based on the image comparison. According to other illustrative embodiments, a computer system and a computer program product for detecting suspicious domains are provided.

### BRIEF DESCRIPTION OF THE DRAWINGS

FIG. 1 is a pictorial representation of a network of data processing systems in which illustrative embodiments may be implemented;

FIG. 2 is a block diagram of a suspicious domain environment in accordance with an illustrative embodiment;

FIG. 3 is an illustration of a suspicious domain classifier in accordance with an illustrative embodiment;

FIG. 4 is a dataflow diagram for comparing domain names for domains in accordance with an illustrative embodiment;

FIG. 5 is a data flow diagram for comparing images from a known domain and a target domain in accordance with an illustrative embodiment;

FIG. 6 is a flowchart of a process for detecting suspicious target domains in accordance with an illustrative embodiment;

FIG. 7 is a flowchart of a process for determining a target domain to be not suspicious based on an ownership comparison in accordance with an illustrative embodiment;

FIG. 8 is a flowchart of a process for determining homographic similarity in accordance with an illustrative embodiment;

FIG. 9 is a flowchart of a process for generating canonicalized strings for a known domain in accordance with an illustrative embodiment;

FIG. 10 is a flowchart of a process for comparing images from a known domain and a target domain in accordance with an illustrative embodiment;

FIG. 11 is a flowchart of a process for comparing landing pages from a known domain and a target domain in accordance with an illustrative embodiment;

FIG. 12 is a flowchart of a process for comparing landing pages from a known domain and a target domain using a cosine similarity between images in accordance with an illustrative embodiment;

FIG. 13 is a flowchart of a process for comparing landing page images from a known domain and a target domain in accordance with an illustrative embodiment;

FIG. 14 is a flowchart of a process for determining threat level for a target domain in accordance with an illustrative embodiment;

FIG. 15 is a flowchart of a process for determining a threat level for a target domain in accordance with an illustrative embodiment; and

FIG. 16 is a block diagram of a data processing system in accordance with an illustrative embodiment.

### DETAILED DESCRIPTION

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account a number of different considerations as described herein. For example, the illustrative embodiments recognize and take into account that it is desirable to detect suspicious domains before threats originating from those domains are visible or detected. In performing suspicious domain identification, newly observed domain information for newly observed domains can be leveraged. This newly observed domain information can be obtained from various domain query and response protocol databases that store registered users or assignees of domain names. This registration information with holographic similarity is present and content comparison from landing page images can be performed when the registration information does not indicate that the domains are commonly owned.

In one illustrative example, a computer implemented method detects suspicious domains. A computer system determines a homographic similarity between a target domain and a known domain. The computer system compares first registration information for the target domain and second registration information for the known domain to form a registration comparison in response the homographic similarity being sufficiently similar to be potentially suspicious. The computer system compares a set of first landing page images for the target domain and a set of second landing page images for the known domain to form an image comparison in response to a match between the first ownership information for the target domain and the second ownership information for the known domain being absent. The computer system determines a threat level for the target domain based on the image comparison.

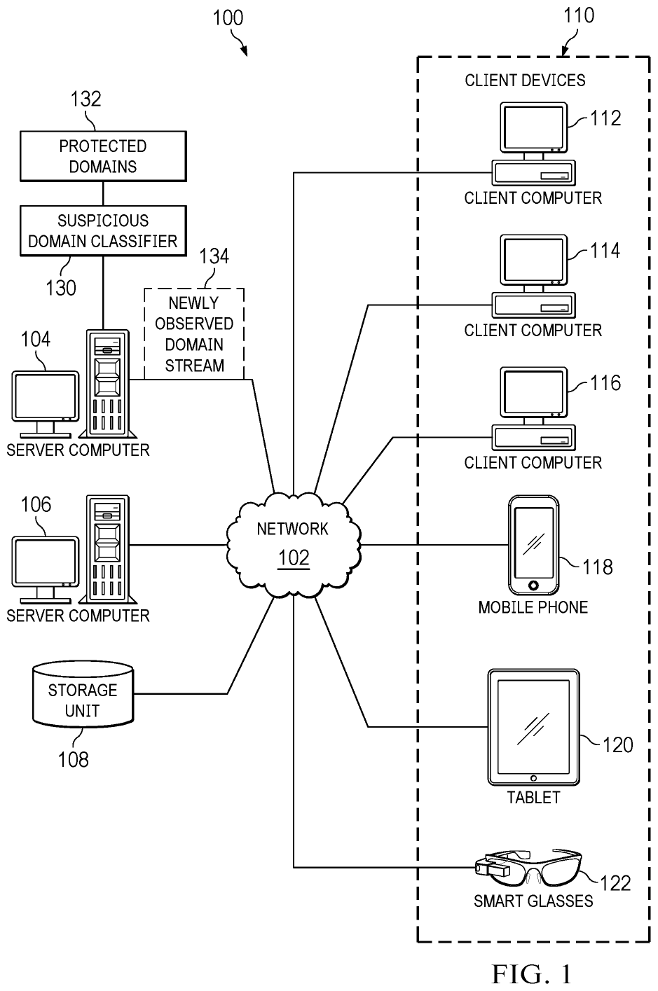

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage media and downloaded to a data processing system or other device for use. For example, program instructions can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In this example, suspicious domain classifier 130 is located in server computer 104. Protected domains 132 is a list of known domains that are to be protected. As depicted, suspicious domain classifier 130 receives newly observed domain stream 134 for analysis. Newly observed the domain stream 134 includes target domains selected for processing to determine whether any of these target domains are considered suspicious domains with respect to the domains in protected domains 132.

In this illustrative example, suspicious domain classifier 130 can determine whether a target domain in newly observed domain stream 134 is a homograph of a protected domain in protected domains 132. In this illustrative example, letters in the target domain can be swapped out with the confusable characters. For example, a number “1” can look like a letter “l” and the letters “r” and “n” put together can look like the letter “m”. Further, the protected domain can also have letters swapped out with confusable characters. These results can be compared to determine whether the target domain is a homograph of the protected domain.

If the target domain is determined to be a homograph of the protected domain, suspicious domain classifier 130 can determine whether the two domains are under the same owner before performing additional analysis. This determination can be made using at least one of registration information or name servers in domain registration records such as WHOIS records. If the registration information indicates that the two domains are owned by the same owner, then the target domain is not considered suspicious. In some cases, the registration information for one or both domains may not be sufficient to make this comparison of ownership with a sufficient level of certainty. In this illustrative example, the registration may only include an owner name and not an email address or other information that can confirm that the target domain and the protected domain had the same owner. In this case, name servers can also be used to determine whether the two domains belong to the same owner.

If registration information indicates different owners or insufficient registration information is present, the content in the two domains can be analyzed. For example, images of the landing pages for the two domains can be compared. For example, randomly sampled images of the landing pages for the last 30 days can be obtained and compared for each domain to determine the similarity between the landing pages. If the similarity is greater than a threshold, the two domains can be considered similar.

If the similarity is less than the threshold, the target domain can be considered suspicious. In this case, the target domain can be considered a threat and an action can be taken such as generating an alert, sending a message, initiate removal of the target domain, or performing some other suitable action.

If the similarity between the landing pages for the target domain and the protected domain are not considered similar and the registration information cannot confirm that both domains belong to the same owner, the target domain can be flagged as suspicious. This information can be used in an analysis if the target domain becomes a threat at a later point in time.

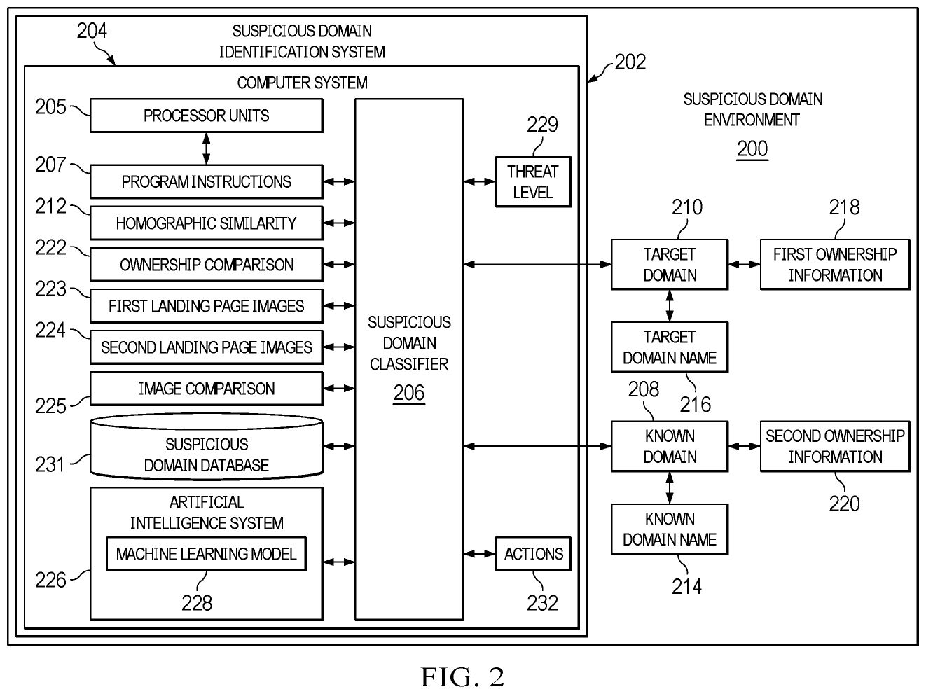

With reference now to FIG. 2, a block diagram of a suspicious domain environment is depicted in accordance with an illustrative embodiment. In this illustrative example, suspicious domain environment 200 includes components that can be implemented in hardware such as the hardware shown in network data processing system 100 in FIG. 1.

In this illustrative example, suspicious domain identification system 202 comprises computer system 204 and suspicious domain classifier 206. Suspicious domain classifier 206 is located in computer system 204.

Suspicious domain classifier 206 can be implemented in software, hardware, firmware, or a combination thereof. When software is used, the operations performed by suspicious domain classifier 206 can be implemented in program instructions configured to run on hardware, such as a processor unit. When firmware is used, the operations performed by program instructions 207 can be implemented in program instructions and data and stored in persistent memory to run on a processor unit. When hardware is employed, the hardware can include circuits that operate to perform the operations in suspicious domain classifier 206.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes a number of processor units 205 that are capable of executing program instructions 207 implementing processes in the illustrative examples. As used herein a processor unit in the number of processor units 205 is a hardware device and is comprised of hardware circuits such as those on an integrated circuit that respond and process instructions and program instructions that operate a computer. When a number of processor units 205 execute program instructions 207 for a process, the number of processor units 205 is one or more processor units that can be on the same computer or on different computers. In other words, the process can be distributed between processor units on the same or different computers in a computer system. Further, the number of processor units 205 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, known domain 208 is a domain selected for protection. Threats or potential threats to known domain 208 can be identified by suspicious domain classifier 206. Target domain 210 is a domain identified for analysis by suspicious domain classifier 206 to determine whether target domain 210 is suspicious or a threat with respect to known domain 208. In one illustrative example, target domain 210 can be a newly observed domain received in a newly observed domain stream. In other illustrative examples, target domain 210 can be received in a request from a requester for analysis.

As depicted, suspicious domain classifier 206 determines homographic similarity 212 between target domain 210 and known domain 208. Homographic similarity 212 can be determined by analyzing known domain name 214 for known domain 208 and target domain name 216 for target domain 210.

In response to homographic similarity 212 being sufficiently similar to be potentially suspicious, suspicious domain classifier 206 searches for first ownership information 218 for target domain 210 and second ownership information 220 for known domain 208. The ownership information can be obtained using query and response protocols such as WHOIS to query databases of registered users for ownership information about domain names.

In this illustrative example, suspicious domain classifier 206 can compare first ownership information 218 for target domain 210 and second ownership information 220 for known domain 208 to form ownership comparison 222 in response to homographic similarity 212 being sufficiently similar to be potentially suspicious. The ownership information can include at least one of registration information, name servers, or other information that can be used to identify the owner of a domain. In this depicted example, sufficient registration information is present when a registered organization name and an email address are included in the registration information. If the registration information includes only a name, that information is considered to be insufficient to determine whether both domains belong to the same owner. In this case, the identification of name servers for the two domains can be used to determine whether the owner of the domains is the same, in addition to using the name in the registration information.

As depicted, suspicious domain classifier 206 can determine that target domain 210 is not suspicious in response to ownership comparison 222 indicating a match between first ownership information 218 of target domain 210 and second ownership information 220 of known domain 208. A match is present when sufficient information is available in both first ownership information 218 and second ownership information 220 that matches each other.

For example, if both sets of ownership information include owner name and an email address and those two pieces of information match, then ownership comparison 222 indicates that a match is present between first ownership information 218 and second ownership information 220. Thus, target domain 210 and known domain 208 are considered to be owned by the same owner and threat level 229 in this example can indicate that a threat is absent. On the other hand, if insufficient ownership information is present to compare ownership between target domain 210 and known domain 208, then a match is absent between first ownership information 218 and second ownership information 220.

In this illustrative example suspicious domain classifier 206 compares a set of first landing page images 223 for target domain 210 and a set of second landing page images 224 for known domain 208 to form image comparison 225 in response to a match between ownership information between target domain 210 and known domain 208 being absent. In this illustrative example, image comparison 225 can be made using program instructions 207 suspicious domain classifier 206.

In other illustrative examples, suspicious domain classifier 206 can make this determination using artificial intelligence system 226. An artificial intelligence system is a system that has intelligent behavior and can be based on the function of a human brain. An artificial intelligence system comprises at least one of an artificial neural network, a cognitive system, a Bayesian network, a fuzzy logic, an expert system, a natural language system, or some other suitable system. Machine learning is used to train the artificial intelligence system. Machine learning involves inputting data to the process and allowing the process to adjust and improve the function of the artificial intelligence system.

In one illustrative example, artificial intelligence system 226 can comprise machine learning model 228. A machine learning model is a type of artificial intelligence model that can learn without being explicitly programmed. A machine learning model can learn based on training data input into the machine learning model. The machine learning model can learn using various types of machine learning algorithms. The machine learning algorithms include at least one of a supervised learning, and unsupervised learning, a feature learning, a sparse dictionary learning, an anomaly detection, a reinforcement learning, a recommendation learning, or other types of learning algorithms. Examples of machine learning models include an artificial neural network, a convolutional neural network, a decision tree, a support vector machine, a regression machine learning model, a classification machine learning model, a random forest learning model, a Bayesian network, a genetic algorithm, and other types of models. These machine learning models can be trained using data and process additional data to provide a desired output.

With image comparison 225, suspicious domain classifier 206 can determine threat level 229 for target domain 210 based on image comparison 225. Suspicious domain classifier 206 performs this type of analysis for each domain selected for protection or monitoring. Based on threat level 229, suspicious domain classifier 206 can form a set of actions 232. The set of actions 232 can be selected from at least one of flagging target domain 210 for additional monitoring, generating an early warning, sending a message to a user, initiating a cybersecurity process, or other actions. For example, if threat level 229 indicates that target domain 210 is suspicious but not an actual threat, suspicious domain classifier 206 can store information about target domain 210 in suspicious domain database 231 for further monitoring or historical analysis. If threat level 229 indicates that target domain 210 is a threat, suspicious domain classifier 206 can generate an early warning such that the additional actions can be taken with respect to target domain 210. These actions can be taken before target domain 210 becomes active if target domain 210 is not already active.

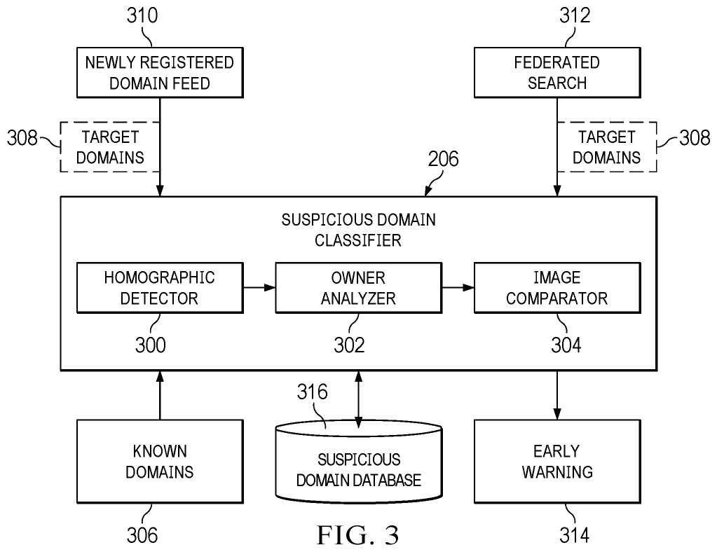

Turning to FIG. 3, an illustration of a suspicious domain classifier is depicted in accordance with an illustrative embodiment. Components that can be used to implement suspicious domain classifier 206 are shown in this figure. As depicted, suspicious domain classifier 206 can include homographic detector 300, owner analyzer 302, and image comparator 304. As depicted, these components form an intelligence generation pipeline for classifying target domains with respect to known domains selected for protection in performing threat intelligence curation.

Suspicious domain classifier 206 can operate to detect threats to known domains which are selected for protection. In this illustrative example, suspicious domain classifier 206 can operate to detect threats to known domains 306. In this depicted example, known domains 306 are domains that have been selected for protection.

In this illustrative example, suspicious domain classifier 206 can receive target domains 308 from newly registered domain feed 310 and federated search 312. Newly registered domain feed 310 can be received from sources such as Quad 9, which is a domain name system (DNS) platform. Federated search 312 can be a search performed on multiple data sources such as domain name registry databases maintained by domain name registrars.

In this illustrative example, homographic detector 300 determines the homographic similarity between a target domain and a known domain. This homographic similarity can be determined by creating a canonicalized version of the target domain and the known domain. These canonicalized versions of the target domain and the known domain can be compared to determine the level of homographic similarity between these canonicalized versions.

If homographic similarity is at a level to be suspicious, then owner analyzer 302 operates to attempt to determine the ownership of the target domain and the known domain. This analysis can be performed using ownership information such as registration information, domain name servers, and other information that can be obtained from various sources. In one illustrative example, source can be WHOIS. If owner analyzer 302 determines that both the target domain and the known domain have the same owner, then the process can terminate or move to analyze another target domain.

In this case, the target domain is not a suspicious domain because of the common ownership. If insufficient information is present to determine ownership or the ownership information indicates that different owners are present, image comparator 304 performs content comparison between the target domain and the known domain. In this illustrative example, the content comparison compares the landing pages for the target domain and the known domain. In the illustrative example, image comparator 304 obtains screenshots of the landing pages for the target domain and the known domain.

These screenshots can be images of the landing pages over a period of time. For example, landing pages present for a 30 day period of time can be used for the comparison. In other illustrative examples, images from other periods of time such as 5 days, 60 days, or some other period of time can be used.

The images are compared by image comparator 304 to determine the similarity between images for the target domain and images for the known domain. A threshold level of similarity can be set for use in determining when images for landing pages between a target domain and a known domain are considered to be sufficiently similar to be considered to be a threat in response to an inability to determine that the two domains have the same owner. In other words, when the similarity exceeds the threshold, the target domain is not considered a threat. If the threshold is exceeded, then suspicious domain classifier 206 can generate early warning 314. Early warning 314 can be a message, email, signal, or other indicator. Early warning 314 can be used to initiate action to prevent or eliminate potential issues that can be caused by the target domain that has been identified as a threat.

In this illustrative example, if the target domain does not have a landing page but is identified as having different owners based on insufficient information being present to determine owners, then the target domain is identified as a suspicious domain. This target domain can be added to suspicious domain database 316. Additional information about the target domain such as name server, IP address, geography, or the information can be included. This information can be useful in the event that the target domain later becomes a threat. In this manner, and historical analysis can be performed to determine what suspicious target domains later become actual threats. The analysis may reveal various patterns such as suspicious domains from certain geographies often become threats.

Thus, suspicious domain classifier 206 provides an improved process for detecting suspicious domains including phishing domains based on homographic similarity, ownership analysis, and image similarity. In the illustrative example, suspicious domain classifier 206 provides lower false-positive rates as compared to currently available techniques. Further, improved accuracy occurs through comparison of landing page images using artificial intelligence system 226 and in particular machine learning model 228 in FIG. 2.

In one illustrative example, one or more technical solutions are present that overcome a technical problem with the use of suspicious domains to divert traffic from known domains selected for protection. As a result, one or more technical solutions may provide a solution that detects suspicious domains by applying multiple types of analysis as a pipeline in curating threat intelligence related to domain names.

Computer system 204 can be configured to perform at least one of the steps, operations, or actions described in the different illustrative examples using software, hardware, firmware, or a combination thereof. As a result, computer system 204 operates as a special purpose computer system in which suspicious domain classifier 206 in computer system 204 enables detecting suspicious domains that may be a threat to known domains identified for protection. In particular, suspicious domain classifier 206 transforms computer system 204 into a special purpose computer system as compared to currently available general computer systems that do not have suspicious domain classifier 206.

In the illustrative example, the use of suspicious domain classifier 206 in computer system 204 integrates different processes into a practical application detecting suspicious domains that increases the performance of computer system 204 in curating threat intelligence for protecting domains. In other words, suspicious domain classifier 206 in computer system 204 is directed to a practical application of processes integrated into suspicious domain classifier 206 in computer system 204 performs at least one of homographic detection, domain ownership detection, and image analysis of screenshots from landing pages of target domains and known domains.

The illustration of suspicious domain environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

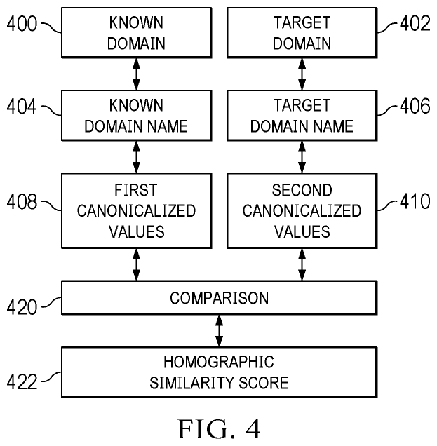

With reference next to FIG. 4, a dataflow diagram for comparing domain names for domains is depicted in accordance with an illustrative embodiment. As depicted, the dataflow in this figure can be implemented using suspicious domain classifier 206 and more specifically can be implemented in homographic detector 300 in suspicious domain classifier 206 in FIG. 3.

In this illustrative example, the homographic similarity between known domain 400 and target domain 402 can be determined through canonicalization of known domain name 404 for known domain 400 and target domain name 406 for target domain 402. As depicted, first canonicalized values 408 are generated using the string of known domain name 404. Second canonicalized values 410 are identified using the string of target domain 402.

In this illustrative example, first canonicalized values 408 from a database or data structure containing canonicalized values for known domains are selected for protection. First canonicalized values 408 are generated for known domain 400 prior to initiating the process in this flowchart and saved for quicker process initialization in this example. As a result, comparison 420 can be performed more quickly. Processor resource savings and time savings increase when thousands or tens of thousands of target domains are received for analysis. Thus, the identification of first canonicalized values 408 can be performed as a lookup in a database or other type of data structure.

In this illustrative example, if known domain name 404 is “lionhorne.com”, first canonicalized values 408 can be, for example, “l1onhorne.com”, “lionhorne3.com”, and “lionhime.com”. If target domain name 406 is “lionhome.com”, second canonicalized values 410 can be, for example “lionhorne.com”, “lionhorn3.com”, and “l1onhorne.com”. In this example, comparison 420 compares first canonicalized values 408 and second canonicalized values 410 to determine homographic similarity score 422 between known domain 400 and target domain 402.

In another illustrative example, second canonicalized values 410 are generated from target domain name 406. In this implementation, first canonicalized values 408 do not need to be generated. Instead, second canonicalized values 410 can be compared to known domain name 404 to determine if a match is present. In yet another example, first canonicalized values 408 are generated and compared to target domain name 406 to determine if a match is present. With this example, second canonicalized values 410 are not generated as part of the comparison process.

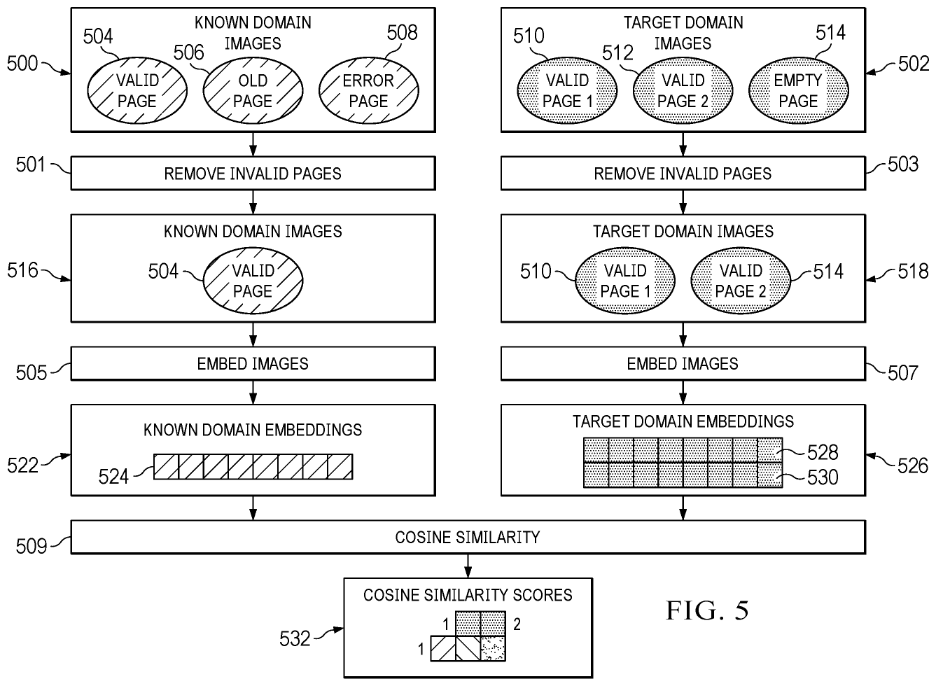

Turning now to FIG. 5, a data flow diagram for comparing images from a known domain and a target domain is depicted in accordance with an illustrative embodiment. The dataflow in this figure can be implemented using suspicious domain classifier 206 and more specifically can be implemented in image comparator 304 in suspicious domain classifier 206 in FIG. 3. As depicted, known domain images 500 and target domain images 502 are identified for comparison. These images are screenshots of landing pages in the depicted examples. Landing pages can also be referred to as homepages in these examples. The comparison of these images is performed to determine whether the images are sufficiently similar to indicate that they are from the same source. In this illustrative example, this data flow can be implemented in an artificial intelligence system in the form of a machine learning model. More specifically, a convolutional neural network can be used in this dataflow.

In this illustrative example, known domain images 500 include valid page 504, old page 506, and error page 508. Old page 506 is a screenshot of the page that is outside of the time used for comparison. For example, if the images are for screenshots of landing pages from the last 30 days, old page 506 may be from day 32. Error page 508 is a page that displays an error code.

Target domain images 502 include valid page 1 510, valid page 2 512, an empty page 514. Empty page 514 is the image of the page that has no content.

In this example, invalid pages are removed from known domain images (block 501). The result is known domain images 516, which comprises valid page 504. Invalid pages are removed from target domain images 502 (block 503). This processing of target domain images 502 result in in target domain images 518. In this example, target domain images 518 are valid page 1 510 and valid page 2 514.

Next, known domain images 516 are embedded (block 505). In this example, known domain images 516 comprises valid page 504. This embedding results in known domain embeddings 522 which comprises a single embedding, known domain embedding 524. Target domain images 518 are also embedded (block 507). This embedding forms target domain embeddings 526, which comprises target domain embedding 1 528 and target domain embedding 2 530. In other words, each image that is embedded results in an embedding. This embedding takes the form of vectors of numbers that describe the images processed to produce these embeddings.

Cosine similarity is then determined for the embedding (block 509), resulting in cosine similarity scores 532. Cosine similarity is measured by the cosine of the angle between two vectors and determines whether the two vectors are pointing in roughly the same direction. A cosine similarity score of one is for similar and a cosine similarity score of zero is for unrelated in this illustrative example.

These scores than can be examined to determine whether images of the landing pages from the known domain and the target domain are sufficiently similar to not be considered suspicious or a threat. In this example, cosine similarity is determined between known domain embedding 524 and target domain embedding 1 528. In this illustrative example, cosine similarity measures the similarity between two vectors of an inner product space. In this illustrative example, the two vectors can be known domain embedding 524 and target domain embedding 1 528. The two vectors can also be known domain embedding 524 and target domain embedding 2 530. Cosine similarity is measured by the cosine of the angle between two vectors and determines whether two vectors are pointing in roughly the same direction. Cosine similarity is also determined between known domain embedding 524 and target domain embedding 2 530.

In this example, insufficient information is present to determine both the names have the same ownership or the ownership information indicates that different owners are present, resulting in comparing images from the known domain and the target domain to generate the cosine similarity scores 532 of the domains in a cosine similarity score matrix. If cosine similarity scores 532 is less than a similarity threshold, then the two images from the two domains are not sufficiently similar, and the target domain is not considered a threat. In other words, although different owners are present for the two domains, the landing pages are sufficiently different such that a user would not confuse the landing page for the target domain with the landing page for the known domain.

If cosine similarity scores 532 are equal to or greater than the similarity threshold, then the two images from the two domains are considered to be sufficiently similar. In one illustrative example, the cosine similarity threshold can be 0.9.

If cosine similarity scores 532 indicate that the two domains are sufficiently similar, a determination can be made as to whether this score is due to an outlier. A determination of whether an outlier is present can be determined in block 509 by calculating the average absolute distance from the mean and dividing the absolute difference of each score by the average. This determination is less sensitive version of a standard deviation for normalized vector similarity scores. If the maximum similarity after this pruning step is still above the threshold, the image comparison step generates an early warning identifying the target domain as a threat.

In this example, if a subsequent comparison of the domains at the image comparison step results in cosine similarity scores 532 being equal to or greater than the similarity threshold and cosine similarity scores 532 were previously less than the similarity threshold at the image comparison step, an analysis can be performed on cosine similarity scores 532 in the future to determine if the generation of the early warning identifying the target domain as a threat. For example, two domains have cosine similarity scores 532 of 0.5, which are less than the similarity threshold of 0.9 in a number of past comparisons. In this example, a subsequent comparison of the two domains generates cosine similarity scores 532 equal to or greater than the similarity threshold of 0.9. In this example, an analysis can be performed at the image comparison step using new screenshots of the known domain and the target domain to determine whether the new scores are outliers.

In the illustrative example, the embedding performed in block 505 and block 507 can be implemented using a machine learning model. For example, the machine learning model can be a convolutional neural network (CNN). In this example, the convolutional neural network operates as an image embedding model to generate embedding of the images in the form of vectors for comparison.

For example, the convolutional neural network can be trained on triplets of images. The three images in a triplet include (1) a baseline image, known as the anchor; (2) a positive example, which is a screenshot under the same domain; and (3) a negative example, a randomly selected screenshot from outside the domain. The anchor to positive model is trained to predict a similarity of 1. This model is a first image comparison model. The anchor to negative is trained to predict a similarity of 0. This model is the second image comparison model. When two comparisons are performed using these two models, those comparisons provide sufficient evidence during training to consider the vectors of the 3 images to be the fingerprints of the compared images.

In the illustrative example, the training process randomly samples a screenshot for a particular domain. This first screenshot is used as anchor. The process randomly samples another screenshot under that same domain. This second screenshot is used as positive reference. The process randomly samples a screenshot for any other domain. This third screen shot is used as negative reference.

The process embeds all 3 images, resulting in 3 vectors. The process calculates cosine similarity between anchor and positive vectors and calculates the cosine similarity between anchor and negative vectors. The process retunes embedding model and comparison models such that the anchor generates positive scores as 1 and anchor generates negative scores as 0. The retuned embedding model can be used to generate the vectors for the cosine similarity check performed in block 509.

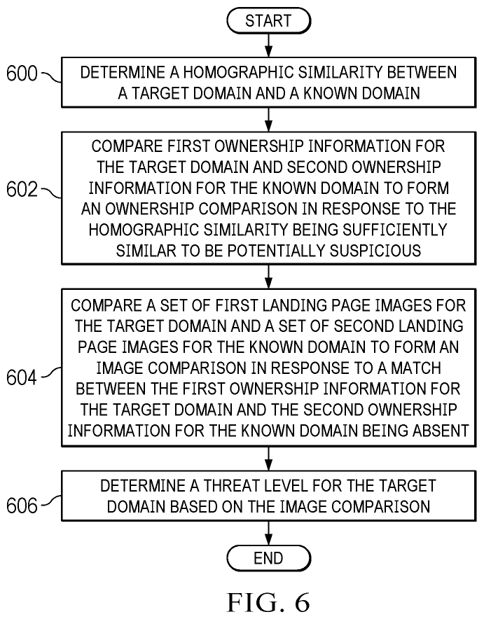

With reference to FIG. 6, a flowchart of a process for detecting suspicious target domains is depicted in accordance with an illustrative embodiment. The process illustrated in FIG. 6 can be implemented using computer system 204 in FIG. 2. For example, the process can be implemented in suspicious domain classifier 206 in computer system 204 in domain identification system 202 in FIG. 2.

The process begins by determining a homographic similarity between a target domain and a known domain (step 600). The process compares first ownership information for the target domain and second ownership information for the known domain to form an ownership comparison in response to the homographic similarity being sufficiently similar to be potentially suspicious (step 602).

The process compares a set of first landing page images for the target domain and a set of second landing page images for the known domain to form an image comparison in response to a match between the first ownership information for the target domain and the second ownership information for the known domain being absent (step 604). The process determines a threat level for the target domain based on the image comparison (step 606). The process terminates thereafter.

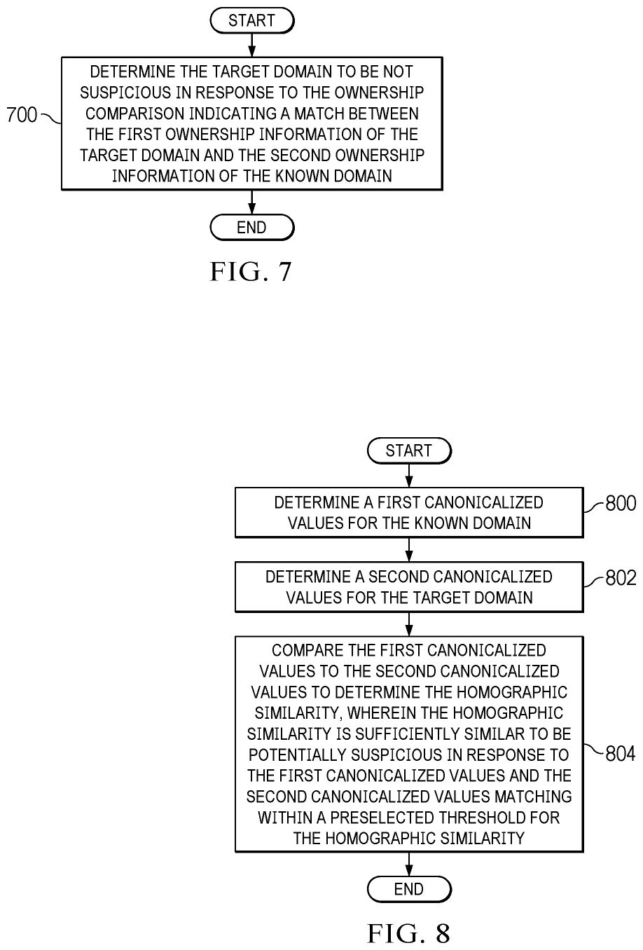

Turning next to FIG. 7, a flowchart of a process for determining a target domain to be not suspicious based on an ownership comparison is depicted in accordance with an illustrative embodiment. The step in this figure is an example of an additional step that can be used within the steps in the process in FIG. 6.

The process determines the target domain to be not suspicious in response to the ownership comparison indicating a match between the first ownership information of the target domain and the second ownership information of the known domain (step 700). The process terminates thereafter.

With reference to FIG. 8, a flowchart of a process for determining homographic similarity is depicted in accordance with an illustrative embodiment. The process illustrated in FIG. 8 is an example of one implementation for step 600 in FIG. 6.

The process begins by determining a first canonicalized values for the known domain (step 800). In this example, step 800 can be performed as a look of first canonicalized values for the known domain that were previously generated. In other examples, the generation of the first canonicalized values can occur in step 800. The process determines a second canonicalized values for the target domain (step 802).

The process compares the first canonicalized values to the second canonicalized values to determine the homographic similarity, wherein the homographic similarity is sufficiently similar to be potentially suspicious in response to the first canonicalized values and the second canonicalized values matching within a preselected threshold for the homographic similarity (step 804). The process terminates thereafter.

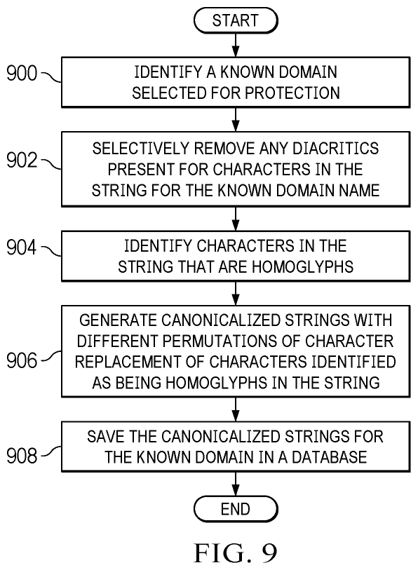

Turning next to FIG. 9, a flowchart of a process for generating canonicalized strings for a known domain is depicted in accordance with an illustrative embodiment. The process in FIG. 9 can be implemented in hardware, software, or both. When implemented in software, the process can take the form of program instructions that is run by one of more processor units located in one or more hardware devices in one or more computer systems. For example, the process can be implemented in suspicious domain classifier 206 in computer system 204 in FIG. 2.

The process begins by identifying a known domain selected for protection (step 900). The process selectively removes any diacritics present for characters in the string for the known domain name are selectively removed (step 902). A diacritic is a sign associated with the character. For example, a diacritic can be accent or cedilla.

The process identifies characters in the string that are homoglyphs (step 904). In step 904, the process determines whether one or more other characters appear identical or very similar to the character been processed. For example, when next to each other “r” and “n” can resemble “m” This determination can be made using a Unicode character set containing Unicode homoglyphs of characters also referred to as confusables.

The process generates canonicalized strings with different permutations of character replacement of characters identified as being homoglyphs in the string (step 906). The process saves the canonicalized strings for the known domain in a database (step 908). The process terminates thereafter.

This process in FIG. 9 can be performed for known domains that is selected for protection. The results of this process can be saved in a database for faster comparisons to identify target domains with homographic similarity to known domains.

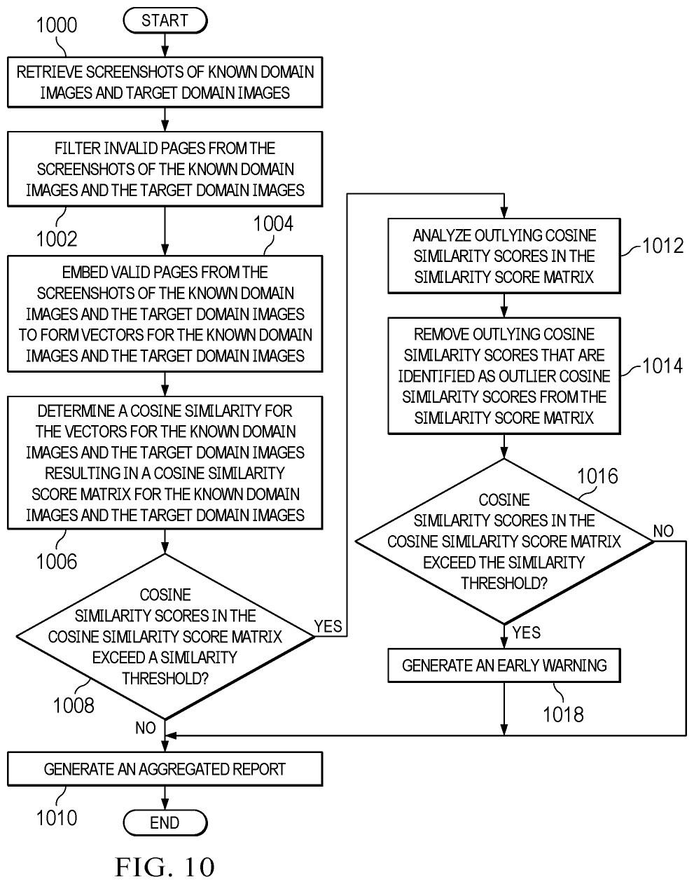

With reference now to FIG. 10, a flowchart of a process for comparing images from a known domain and a target domain is depicted in accordance with an illustrative embodiment. The process illustrated in FIG. 10 can be implemented using computer system 204 in FIG. 2. For example, the process can be implemented in suspicious domain classifier 206 in computer system 204 in FIG. 2.

The process begins by retrieving screenshots of known domain images and target domain images (step 1000). The process filters invalid pages from the screenshots of the known domain images and the target domain images (step 1002). The process embeds valid pages from the screenshots of the known domain images and the target domain images to form vectors for the known domain images and the target domain images (step 1004).

The process determines a cosine similarity for the vectors for the known domain images and the target domain images resulting in a cosine similarity score matrix for the known domain images and the target domain images (step 1006). The cosine similarity score matrix is a data structure that contains scores between the images. For example, if 2 know domain images and 3 target domain images are embedded and compared, the cosine similarity score matrix is a 2 by 3 matrix with each score representing an image from the known domain and an image from the target domain. In this depicted example, if 1 know domain image and 2 target domain images are embedded and compared, the cosine similarity score matrix is a 1 by 2 matrix.

A determination is made as to whether cosine similarity scores in the cosine similarity score matrix exceed a similarity threshold (step 1008). If none of the cosine similarity scores exceed the similarity threshold, the process generates an aggregated report (step 1010). The process terminates thereafter.

With reference again to step 1008, if the cosine similarity scores exceed a similarity threshold, then the process analyzes outlying cosine similarity scores in the similarity score matrix (step 1012). The process removes outlying cosine similarity scores that are identified as outlier cosine similarity scores from the similarity score matrix (step 1014). A determination is made as to whether the cosine similarity scores in the cosine similarity score matrix exceed the similarity threshold (step 1016). If none of the cosine similarity scores exceed the similarity threshold, then the process generates an aggregated report (step 1010). The process terminates thereafter. With reference again to step 1016, if the cosine similarity scores exceed the similarity threshold, then the process generates an early warning (step 1018). The process generates an aggregated report (step 1010). The process terminates thereafter.

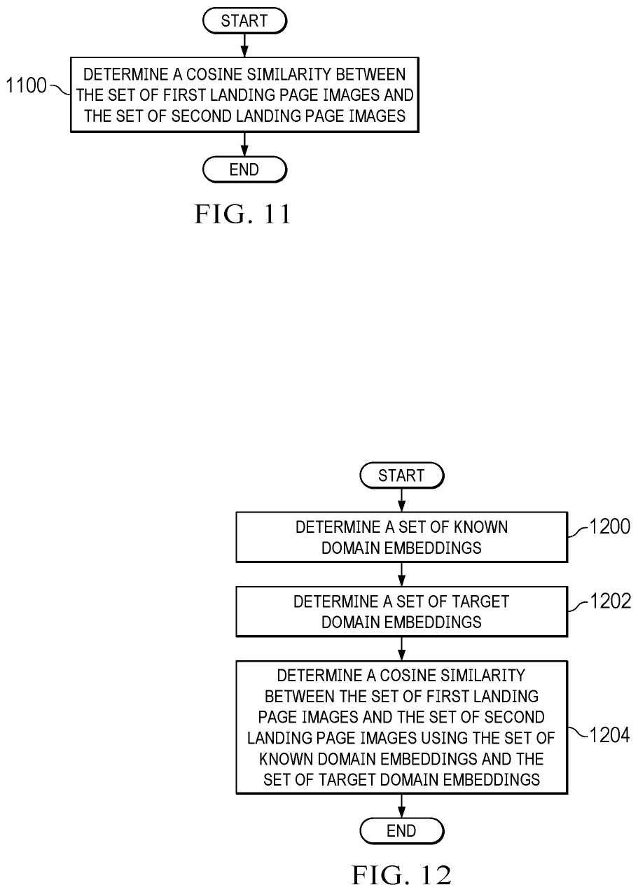

With reference now to FIG. 11, a flowchart of a process for comparing landing pages from a known domain and a target domain is depicted in accordance with an illustrative embodiment. The process illustrated in FIG. 11 is an example of one implementation for step 604 in FIG. 6.

The process determines a cosine similarity between the set of first landing page images and the set of second landing page images (step 1100). The process terminates thereafter.

Turning next to FIG. 12, a flowchart of a process for comparing landing pages from a known domain and a target domain using a cosine similarity between images is depicted in accordance with an illustrative embodiment. The process illustrated in FIG. 12 is an example of one implementation for step 604 in FIG. 6.

The process begins by determining a set of known domain embeddings (step 1200). The process determines a set of target domain embeddings (step 1202). The process determines a cosine similarity between the set of first landing page images and the set of second landing page images using the set of known domains embeddings and the set of target domain embeddings (step 1204). The process terminates thereafter.

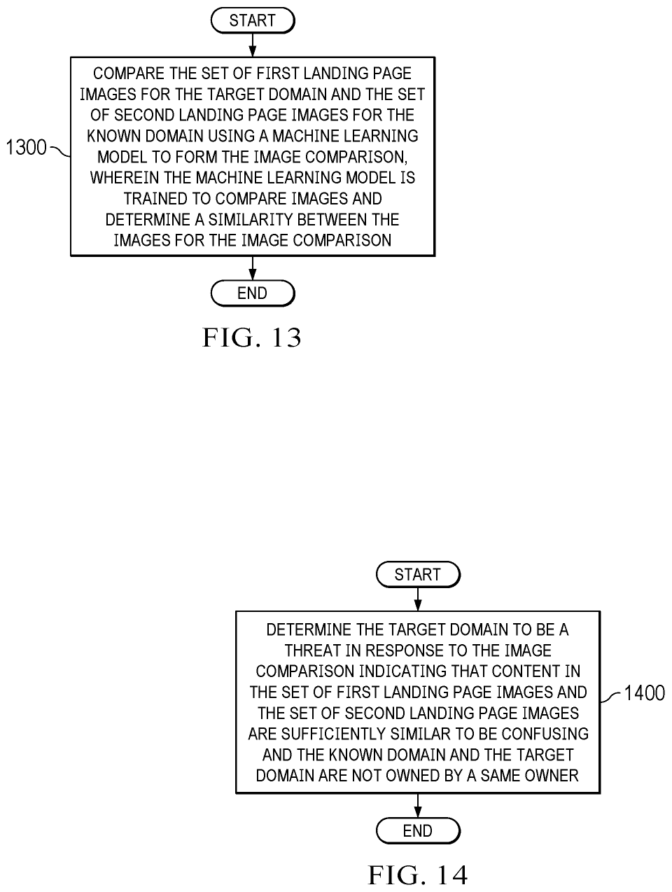

With reference to FIG. 13, a flowchart of a process for comparing landing page images from a known domain and a target domain is depicted in accordance with an illustrative embodiment. The process illustrated in FIG. 13 is an example of one implementation for step 604 in FIG. 6.

The process compares the set of first landing page images for the target domain and the set of second landing page images for the known domain using a machine learning model to form the image comparison, wherein the machine learning model is trained to compare images and determine a similarity between the images for the image comparison (step 1300). The process terminates thereafter.

Turning to FIG. 14, a flowchart of a process for determining threat level for a target domain is depicted in accordance with an illustrative embodiment. The process illustrated in FIG. 14 is an example of one implementation for step 606 in FIG. 6.

The process determines the target domain to be a threat in response to the image comparison indicating that content in the set of first landing page images and the set of second landing page images sufficiently similar to be confusing and the known domain and the target domain are not owned by a same owner (step 1400). The process terminates thereafter.

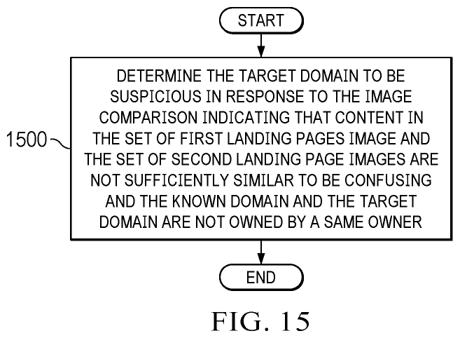

Turning next to FIG. 15, a flowchart of a process for determining a threat level for a target domain is depicted in accordance with an illustrative embodiment. The process illustrated in FIG. 15 is an example of one implementation for step 606 in FIG. 6.

The process determines the target domain to be suspicious in response to the image comparison indicating that content in the set of first landing pages image and the set of second landing page images are not sufficiently similar to be confusing and the known domain and the target domain are not owned by a same owner (step 1500). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

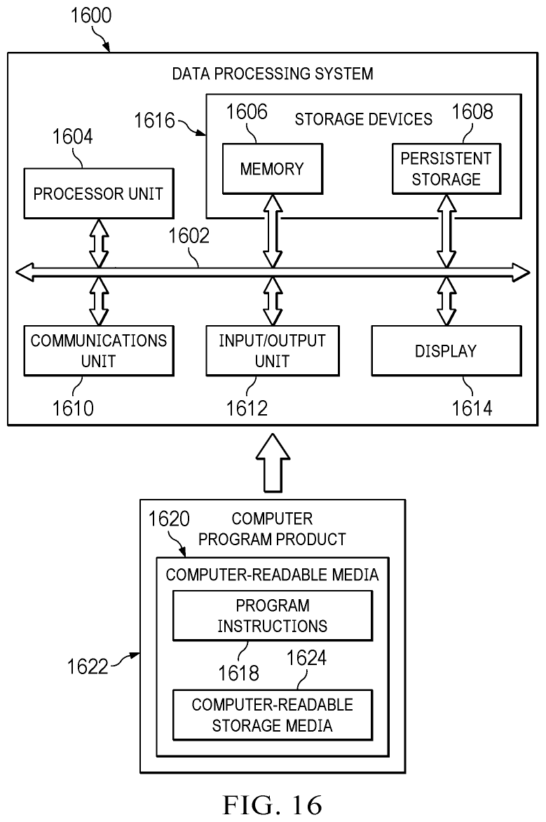

Turning now to FIG. 16, a block diagram of a data processing system is depicted in accordance with an illustrative embodiment. Data processing system 1600 can be used to implement server computer 104, server computer 106, client devices 110, in FIG. 1. Data processing system 1600 can also be used to implement computer system 204 in FIG. 2. In this illustrative example, data processing system 1600 includes communications framework 1602, which provides communications between processor unit 1604, memory 1606, persistent storage 1608, communications unit 1610, input/output unit 1612, and display 1614. In this example, communications framework 1602 takes the form of a bus system.

Processor unit 1604 serves to execute instructions for software that can be loaded into memory 1606. Processor unit 1604 includes one or more processors. For example, processor unit 1604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1604 can may be implemented using one or more heterogeneous processor systems in which a main processor is present with secondary processors on a single chip. As another illustrative example, processor unit 1604 can be a symmetric multi-processor system containing multiple processors of the same type on a single chip.

Memory 1606 and persistent storage 1608 are examples of storage devices 1616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1616 may also be referred to as computer-readable storage devices in these illustrative examples. Memory 1606, in these examples, can be, for example, a random-access memory or any other suitable volatile or non-volatile storage device. Persistent storage 1608 may take various forms, depending on the particular implementation.

For example, persistent storage 1608 may contain one or more components or devices. For example, persistent storage 1608 can be a hard drive, a solid-state drive (SSD), a flash memory, a rewritable optical disk, a rewritable magnetic tape, or some combination of the above. The media used by persistent storage 1608 also can be removable. For example, a removable hard drive can be used for persistent storage 1608.

Communications unit 1610, in these illustrative examples, provides for communications with other data processing systems or devices. In these illustrative examples, communications unit 1610 is a network interface card.

Input/output unit 1612 allows for input and output of data with other devices that can be connected to data processing system 1600. For example, input/output unit 1612 may provide a connection for user input through at least one of a keyboard, a mouse, or some other suitable input device. Further, input/output unit 1612 may send output to a printer. Display 1614 provides a mechanism to display information to a user.

Instructions for at least one of the operating system, applications, or programs can be located in storage devices 1616, which are in communication with processor unit 1604 through communications framework 1602. The processes of the different embodiments can be performed by processor unit 1604 using computer-implemented instructions, which may be located in a memory, such as memory 1606.

These instructions are referred to as program instructions, computer usable program instructions, or computer-readable program instructions that can be read and executed by a processor in processor unit 1604. The program instructions in the different embodiments can be embodied on different physical or computer-readable storage media, such as memory 1606 or persistent storage 1608.

Program instructions 1618 is located in a functional form on computer-readable media 1620 that is selectively removable and can be loaded onto or transferred to data processing system 1600 for execution by processor unit 1604. Program instructions 1618 and computer-readable media 1620 form computer program product 1622 in these illustrative examples. In the illustrative example, computer-readable media 1620 is computer-readable storage media 1624.

Computer-readable storage media 1624 is a physical or tangible storage device used to store program instructions 1618 rather than a medium that propagates or transmits program instructions 1618. Computer-readable storage media 1624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1618 can be transferred to data processing system 1600 using a computer-readable signal media. The computer-readable signal media are signals and can be, for example, a propagated data signal containing program instructions 1618. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1620” can be singular or plural. For example, program instructions 1618 can be located in computer-readable media 1620 in the form of a single storage device or system. In another example, program instructions 1618 can be located in computer-readable media 1620 that is distributed in multiple data processing systems. In other words, some instructions in program instructions 1618 can be located in one data processing system while other instructions in program instructions 1618 can be located in one data processing system. For example, a portion of program instructions 1618 can be located in computer-readable media 1620 in a server computer while another portion of program instructions 1618 can be located in computer-readable media 1620 located in a set of client computers.

The different components illustrated for data processing system 1600 are not meant to provide architectural limitations to the manner in which different embodiments can be implemented. In some illustrative examples, one or more of the components may be incorporated in or otherwise form a portion of, another component. For example, memory 1606, or portions thereof, may be incorporated in processor unit 1604 in some illustrative examples. The different illustrative embodiments can be implemented in a data processing system including components in addition to or in place of those illustrated for data processing system 1600. Other components shown in FIG. 16 can be varied from the illustrative examples shown. The different embodiments can be implemented using any hardware device or system capable of running program instructions 1618.

Thus, illustrative embodiments of the present invention provide a computer implemented method, computer system, and computer program product for detecting suspicious domains. In one illustrative example, a determination is made as to whether to domains, a known domain and a target domain are similar enough that the target domain may be a suspicious domain. This determination can be made by determining homographic similarity in which the domain name string of the two domains are canonicalized for comparison.

If the two domains are sufficiently similar enough, a determination is made as to whether the two domains are owned by the same owner. Ownership information such as registrant information and name servers in various databases of registered users of domain names can be used. If enough registration information is present for both domains, the comparison can be made just using the registration information. If insufficient information is present, such as only an organization name, the name servers can also be used. If overall insufficient information is present, then images from landing pages for the two domains are compared. If the images are not sufficiently similar, then the target domain is not considered a threat. Otherwise, an early warning threat alert can be made identifying the target domain as a threat.

As a result, this type of threat information can be sufficiently accurate for various organizations for use in current hunting and incident response. Additionally, these types of comparisons and alerts can be useful in brand monitoring functionality performed for various clients and their domains.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for detecting suspicious domains, the computer implemented method comprising:
determining, by a computer system, a homographic similarity between a target domain and a known domain;
comparing, by the computer system, first ownership information for the target domain and second ownership information for the known domain to form an ownership comparison in response to the homographic similarity being sufficiently similar to be potentially suspicious;
comparing, by the computer system, a set of first landing page images for the target domain and a set of second landing page images for the known domain to form an image comparison in response to a match between the first ownership information for the target domain and the second ownership information for the known domain being absent; and
determining, by the computer system, a threat level for the target domain based on the image comparison.

2. The computer implemented method of claim 1 further comprising:
determining, by the computer system, the target domain to be not suspicious in response to the ownership comparison indicating a match between the first ownership information of the target domain and the second ownership information of the known domain.

3. The computer implemented method of claim 1, wherein determining, by the computer system, the homographic similarity between the target domain and the known domain comprises:
determining, by the computer system, a first canonicalized values for the known domain;
determining, by the computer system, a second canonicalized values for the target domain; and
comparing, by the computer system, the first canonicalized values to the second canonicalized values to determine the homographic similarity, wherein the homographic similarity is sufficiently similar to be potentially suspicious in response to the first canonicalized values and the second canonicalized values matching within a preselected threshold for the homographic similarity.

4. The computer implemented method of claim 1, wherein comparing, by the computer system, the set of first landing page images for the target domain and the set of second landing page images for the known domain to form the image comparison comprises:
determining, by the computer system, a cosine similarity between the set of first landing page images and the set of second landing page images.

5. The computer implemented method of claim 1, wherein comparing, by the computer system, the set of first landing page images for the target domain and the set of second landing page images for the known domain to form the image comparison comprises:
determining, by the computer system, a set of known domain embeddings;
determining, by the computer system, a set of target domain embeddings; and
determining, by the computer system, a cosine similarity between the set of first landing page images and the set of second landing page images using the set of known domain embeddings and the set of target domain embeddings.

6. The computer implemented method of claim 1, wherein comparing, by the computer system, the set of first landing page images for the target domain and the set of second landing page images for the known domain to form the image comparison comprises:
comparing, by the computer system, the set of first landing page images for the target domain and the set of second landing page images for the known domain using a machine learning model to form the image comparison, wherein the machine learning model is trained to compare images and determine a similarity between the images for the image comparison.

7. The computer implemented method of claim 1, wherein determining, by the computer system, the threat level for the target domain based on the image comparison comprises:
determining, by the computer system, the target domain to be a threat in response to the image comparison indicating that content in the set of first landing page images and the set of second landing page images are sufficiently similar to be confusing and the known domain and the target domain are not owned by a same owner.

8. The computer implemented method of claim 1, wherein determining, by the computer system, the threat level for the target domain based on the image comparison comprises:
determining, by the computer system, the target domain to be suspicious in response to the image comparison indicating that content in the set of first landing pages image and the set of second landing page images are not sufficiently similar to be confusing and the known domain and the target domain are not owned by a same owner.

9. The computer implemented method of claim 1, wherein the target domain is a newly observed domain identified from a newly observed domain stream.

10. A computer system comprising:
comprising a number of processor units, wherein the number of processor units executes program instructions to:
determine a homographic similarity between a target domain and a known domain,
compare first ownership information for the target domain and second ownership information for the known domain to form an ownership comparison in response the homographic similarity being sufficiently similar to be potentially suspicious;
compare a set of first landing page images for the target domain and a set of second landing page images for the known domain to form an image comparison in response to a match between first ownership information for the target domain and the second ownership information the known domain being absent; and
determine a threat level for the target domain based on the image comparison.

11. The computer system of claim 10, wherein the number of processor units executes program instructions to:
determine the target domain to be not suspicious in response to the ownership comparison indicating a match between the first ownership information of the target domain and the second ownership information of the known domain.

12. The computer system of claim 10, wherein in determining the homographic similarity between the target domain and the known domain, the number of processor units executes program instructions to:
determine a first canonicalized values for the known domain;
determine a second canonicalized values for the target domain; and
compare the first canonicalized values to the second canonicalized values to determine the homographic similarity, wherein the homographic similarity is sufficiently similar to be potentially suspicious in response to the first canonicalized values and the second canonicalized values matching within a preselected threshold for the homographic similarity.

13. The computer system of claim 10, wherein in comparing the set of first landing page images for the target domain and the set of second landing page images for the known domain to form the image comparison, the number of processor units executes program instructions to:
determine a cosine similarity between the set of first landing page images and the set of second landing page images.

14. The computer system of claim 10, wherein in comparing the set of first landing page images for the target domain and the set of second landing page images for the known domain to form the image comparison, the number of processor units executes program instructions to:
determine a set of known domain embeddings;
determine a set of target domain embeddings; and
determine a cosine similarity between the set of first landing page images and the set of second landing page images using the set of known domain embeddings and the set of target domain embeddings.

15. The computer system of claim 10, wherein in comparing the set of first landing page images for the target domain and the set of second landing page images for the known domain to form the image comparison, the number of processor units executes program instructions to:
compare the set of first landing page images for the target domain and the set of second landing page images for the known domain using a machine learning model to form the image comparison, wherein the machine learning model is trained to compare images and determine a similarity between the images for the image comparison.

16. The computer system of claim 10, wherein in determining the threat level for the target domain based on the image comparison, the number of processor units executes program instructions to:
determine the target domain to be a threat in response to the image comparison indicating that content in the set of first landing page images and the set of second landing page images are sufficiently similar to be confusing and the known domain and the target domain are not owned by a same owner.

17. The computer system of claim 10, wherein in determining the threat level for the target domain based on the image comparison, the number of processor units executes program instructions to:
determine the target domain to be suspicious in response to the image comparison indicating that content in the set of first landing pages image and the set of second landing page images are not sufficiently similar to be confusing and the known domain and the target domain are not owned by a same owner.

18. The computer system of claim 10, wherein the target domain is a newly observed domain identified from a newly observed domain stream.

19. A computer program product for detecting suspicious domains, the computer program product comprising a computer-readable storage medium having program instructions embodied therewith, the program instructions executable by a computer system to cause the computer system to perform a method of:
determining, by the computer system, a homographic similarity between a target domain and a known domain,
comparing, by the computer system, first ownership information for the target domain and second ownership information for the known domain to form an ownership comparison in response the homographic similarity being sufficiently similar to be potentially suspicious;
comparing, by the computer system, a set of first landing page images for the target domain and a set of second landing page images for the known domain to form an image comparison in response to a match between the first ownership information for the target domain and the second ownership information for the known domain being absent; and
determining, by the computer system, a threat level for the target domain based on the image comparison.

20. The computer program product of claim 19 further comprising:
determining, by the computer system, the target domain to be not suspicious in response to the ownership comparison indicating a match between the first ownership information of the target domain and the second ownership information of the known domain.
